(19) United States
(12) Patent Application Publication
(10) Pub. No.: US 2015/0362597 A1
(43) Pub. Date: Dec. 17, 2015

(54) Ephemeris Extension

(71) Applicant: NOKIA TECHNOLOGIES OY, Espoo (FI)

(72) Inventors: Paula Kristiina Syrjärinne, Tampere (FI); Jani Mikael Käppi, Ylojarvi (FI); Jari Tapani Syrjarinne, Tampere (FI)

(21) Appl. No.: 14/759,484

(22) PCT Filed: Jan. 14, 2013
(86) PCT No.: PCT/EP2013/050589

§ 371 Date: Jul. 7, 2015

(51) Int. Cl. G01S 19/20; G01S 19/27

(52) U.S. Cl. CPC G01S 19/20; G01S 19/27

(57) ABSTRACT

Apparatus has at least one processor and at least one memory having computer-readable code stored thereon which when executed controls the at least one processor: to store a model with parameters for extending ephemeris data for a first satellite; to receive first ephemeris data from the first satellite, the first ephemeris data relating to clock error data and/or orbit data for the first satellite at a first time; to receive second ephemeris data from the first satellite, the second ephemeris data relating to clock error data and/or orbit data for the first satellite at a second time; to use the model to predict clock error data and/or orbit data for the first satellite at the second time; to calculate a measure of deviation between the predicted clock error data and/or orbit data for the first satellite at the second time and the clock error data and/or orbit data for the first satellite at the second time as described in the second ephemeris data; to use the measure of deviation to determine whether there is a fault in the model or parameters of the model; and on a positive determination, to refrain from using ranging signals originating from the first satellite in positioning the receiver apparatus.

### FIELD OF THE INVENTION

This invention relates to ephemeris extension.

### BACKGROUND TO THE INVENTION

Assistance data is crucial for a satellite positioning receiver, such as a Global Positioning System (GPS) receiver, to provide location fixes rapidly after starting up.

Assistance data typically consists of a set of information elements carrying reference location, reference time and satellite clock and orbit data. Satellite clock and orbit data together are typically called ephemeris data. Ephemeris data, together with other aiding means available in a mobile phone (such as reference frequency from the cellular modem), boosts and accelerates the performance of an integrated GPS receiver so that a first fix can usually be provided in 5-10 seconds with a 5 metre accuracy. In comparison, a GPS receiver without any pre-existing assistance data cannot provide the first fix in less than 30-40 seconds even in optimal signal reception conditions. In the absence of pre-existing ephemeris data, the GPS receiver needs to decode broadcast ephemeris data (BCE) from signals transmitted by the GPS satellites. Receiving the signals from which the BCE can be decoded contributes significantly to the minimum time to first fix.

Several advances have been made in the recent years to extend the life-time of the assistance data to make it readily available for the GPS receivers, so that the mobile phone does not need to send an assistance data request via a network every time its GPS receiver is activated. The typical life-time of the assistance data is 2-4 hours, after which the data needs to be refreshed from the BCE or from a server on the mobile phone network or a network attached thereto. The life-time is typically limited by the short-lived ephemeris data, which typically in the case of GPS has a validity period of approximately 4 hours, after which the quality of the satellite position information (orbit) quickly degrades. Other satellites systems can have shorter or longer BCE lifetimes, but usually the lifetime is of the order of a few hours, rather than days.

Assistance data provided by a server remote to the GPS receiver can have a relatively long validity period, typically 7 days, if the server has the means to extended the lifetime of ephemeris e.g. by remodelling the satellite orbits and clocks using the information from the previous BCE. Some commercial assistance data providers are able to extend the lifetime even up to 14 days by compromising the positioning accuracy.

### SUMMARY OF THE INVENTION

A first aspect of the invention provides a method comprising:
receiver apparatus:
   storing a model with parameters for extending ephemeris data for a first satellite;
   receiving first ephemeris data from the first satellite, the first ephemeris data relating to clock error data and/or orbit data for the first satellite at a first time;
   receiving second ephemeris data from the first satellite, the second ephemeris data relating to clock error data and/or orbit data for the first satellite at a second time;
   using the model to predict clock error data and/or orbit data for the first satellite at the second time;
   calculating a measure of deviation between the predicted clock error data and/or orbit data for the first satellite at the second time and the clock error data and/or orbit data for the first satellite at the second time as described in the second ephemeris data;
   using the measure of deviation to determine whether there is a fault in the model or parameters of the model; and
   on a positive determination, refraining from using ranging signals originating from the first satellite in positioning the receiver apparatus.

The method may further comprise, on a positive determination, discarding the model for extending ephemeris data for the first satellite.

The method may further comprise, on a positive determination, using received ephemeris data to update the model for extending ephemeris data for the first satellite.

Using the model to predict clock error data and/or orbit data for the first satellite at the second time may comprise using the model and the first ephemeris data to predict dock error data and/or orbit data for the first satellite at the second time.

The method may further comprise:
receiving third ephemeris data from the first satellite, the third ephemeris data relating to clock error data and/or orbit data for the first satellite at a third time;
calculating a second measure of deviation between the predicted clock error data and/or orbit data for the first satellite at the third time and the dock error data and/or orbit data for the first satellite at the third time as described in the third ephemeris data; and
using both measures of deviation to determine whether the model is faulty.

Calculating the measure of deviation between the predicted clock error data and/or orbit data for the first satellite at the second time and the clock error data and/or orbit data for the first satellite at the second time as described in the second ephemeris data may comprise:
calculating a measure of clock error deviation between the predicted clock error data for the first satellite at the second time and the clock error data for the first satellite at the second time as described in the second ephemeris data; and
calculating a measure of orbit data deviation between the orbit data for the first satellite at the second time and the orbit data for the first satellite at the second time as described in the second ephemeris data, and
using the measure of deviation to determine whether the model is faulty may comprise:
   using the measure of clock error deviation and the measure of orbit data deviation to determine whether the model is faulty.

Calculating the measure of deviation between the predicted clock error data and/or orbit data for the first satellite at the second time and the clock error data and/or orbit data for the first satellite at the second time as described in the second ephemeris data may comprise calculating two or more of:
a measure of along-track orbit deviation between the orbit data for the first satellite at the second time and the orbit data for the first satellite at the second time as described in the second ephemeris data;
a measure of radial orbit data deviation between the orbit data for the first satellite at the second time and the orbit data for the first satellite at the second time as described in the second ephemeris data; and
a measure of cross-track orbit data deviation between the orbit data for the first satellite at the second time and the orbit data for the first satellite at the second time as described in the second ephemeris data, and
using the measure of deviation to determine whether the model is faulty may comprise:
   using the calculated measures of orbit data deviation to determine whether the model is faulty.

Using the measure of deviation to determine whether the model is faulty may comprise determining whether the measure of deviation has a predetermined relationship with respect to a threshold.

The method may comprise providing the threshold based on measures of deviation between predicted clock error data and/or orbit data for multiple satellites and clock error data and/or orbit data as described in ephemeris data broadcast by the multiple satellites.

The method may comprise determining whether there is a fault in models or parameters of the models for each of multiple satellites and, on a positive determination, refraining from using ranging signals originating from a set of satellites in positioning the receiver.

Another aspect provides a computer program may comprise machine readable instructions that when executed by computing apparatus controls it to perform the method above.

A second aspect provides apparatus, the apparatus having a least one processor and at least one memory having computer-readable code stored thereon which when executed controls the at least one processor:
to store a model with parameters for extending ephemeris data for a first satellite;
to receive first ephemeris data from the first satellite, the first ephemeris data relating to clock error data and/or orbit data for the first satellite at a first time;
to receive second ephemeris data from the first satellite, the second ephemeris data relating to clock error data and/or orbit data for the first satellite at a second time;
to use the model to predict clock error data and/or orbit data for the first satellite at the second time;
to calculate a measure of deviation between the predicted clock error data and/or orbit data for the first satellite at the second time and the clock error data and/or orbit data for the first satellite at the second time as described in the second ephemeris data;
to use the measure of deviation to determine whether there is a fault in the model or parameters of the model; and
on a positive determination, to refrain from using ranging signals originating from the first satellite in positioning the receiver apparatus.

The computer-readable code when executed may further control the at least one processor, on a positive determination, to discard the model for extending ephemeris data for the first satellite.

The computer-readable code when executed may further control the at least one processor, on a positive determination, to use received ephemeris data to update the model for extending ephemeris data for the first satellite.

The computer-readable code when executed may further control the at least one processor to use the model to predict clock error data and/or orbit data for the first satellite at the second time by using the model and the first ephemeris data to predict dock error data and/or orbit data for the first satellite at the second time.

The computer-readable code when executed may further control the at least one processor:
to receive third ephemeris data from the first satellite, the third ephemeris data relating to clock error data and/or orbit data for the first satellite at a third time;
to calculate a second measure of deviation between the predicted clock error data and/or orbit data for the first satellite at the third time and the dock error data and/or orbit data for the first satellite at the third time as described in the third ephemeris data; and
to use both measures of deviation to determine whether the model is faulty.

The computer-readable code when executed may further control the at least one processor:
to calculate calculating the measure of deviation between the predicted clock error data and/or orbit data for the first satellite at the second time and the clock error data and/or orbit data for the first satellite at the second time as described in the second ephemeris data by:
   calculating a measure of clock error deviation between the predicted clock error data for the first satellite at the second time and the clock error data for the first satellite at the second time as described in the second ephemeris data; and
   calculating a measure of orbit data deviation between the orbit data for the first satellite at the second time and the orbit data for the first satellite at the second time as described in the second ephemeris data, and to use the measure of deviation to determine whether the model is faulty by:
   using the measure of clock error deviation and the measure of orbit data deviation to determine whether the model is faulty.

The computer-readable code when executed may further control the at least one processor:
to calculate the measure of deviation between the predicted clock error data and/or orbit data for the first satellite at the second time and the clock error data and/or orbit data for the first satellite at the second time as described in the second ephemeris data by calculating two or more of:
   a measure of along-track orbit deviation between the orbit data for the first satellite at the second time and the orbit data for the first satellite at the second time as described in the second ephemeris data;
   a measure of radial orbit data deviation between the orbit data for the first satellite at the second time and the orbit data for the first satellite at the second time as described in the second ephemeris data; and
   a measure of cross-track orbit data deviation between the orbit data for the first satellite at the second time and the orbit data for the first satellite at the second time as described in the second ephemeris data, and to use the measure of deviation to determine whether the model is faulty by:
   using the calculated measures of orbit data deviation to determine whether the model is faulty.

The computer-readable code when executed may further control the at least one processor to use the measure of deviation to determine whether the model is faulty by determining whether the measure of deviation has a predetermined relationship with respect to a threshold.

The computer-readable code when executed may further control the at least one processor to provide the threshold based on measures of deviation between predicted dock error data and/or orbit data for multiple satellites and clock error data and/or orbit data as described in ephemeris data broadcast by the multiple satellites.

The computer-readable code when executed may further control the at least one processor to determine whether there is a fault in models or parameters of the models for each of multiple satellites and, on a positive determination, to refrain from using ranging signals originating from a set of satellites in positioning the receiver.

A third aspect provides a computer readable medium having non-transiently stored therein computer code that when executed by one or more processors of receiver apparatus causes them to perform a method comprising:
storing a model with parameters for extending ephemeris data for a first satellite;
receiving first ephemeris data from the first satellite, the first ephemeris data relating to clock error data and/or orbit data for the first satellite at a first time;
receiving second ephemeris data from the first satellite, the second ephemeris data relating to clock error data and/or orbit data for the first satellite at a second time;
using the model to predict clock error data and/or orbit data for the first satellite at the second time;
calculating a measure of deviation between the predicted clock error data and/or orbit data for the first satellite at the second time and the clock error data and/or orbit data for the first satellite at the second time as described in the second ephemeris data;
using the measure of deviation to determine whether there is a fault in the model or parameters of the model; and
on a positive determination, refraining from using ranging signals originating from the first satellite in positioning the receiver apparatus.

The computer code when executed by the one or more processors of the receiver apparatus may cause them to perform, on a positive determination, discarding the model for extending ephemeris data for the first satellite.

The computer code when executed by the one or more processors of the receiver apparatus may cause them to perform, on a positive determination, using received ephemeris data to update the model for extending ephemeris data for the first satellite.

The computer code when executed by the one or more processors of the receiver apparatus may cause them to perform using the model to predict clock error data and/or orbit data for the first satellite at the second time may comprise using the model and the first ephemeris data to predict clock error data and/or orbit data for the first satellite at the second time.

The computer code when executed by the one or more processors of the receiver apparatus may cause them to perform:
receiving third ephemeris data from the first satellite, the third ephemeris data relating to clock error data and/or orbit data for the first satellite at a third time;
calculating a second measure of deviation between the predicted clock error data and/or orbit data for the first satellite at the third time and the dock error data and/or orbit data for the first satellite at the third time as described in the third ephemeris data; and
using both measures of deviation to determine whether the model is faulty.

The computer code when executed by the one or more processors of the receiver apparatus may cause them to perform:
calculating the measure of deviation between the predicted clock error data and/or orbit data for the first satellite at the second time and the clock error data and/or orbit data for the first satellite at the second time as described in the second ephemeris data by:
   calculating a measure of clock error deviation between the predicted dock error data for the first satellite at the second time and the clock error data for the first satellite at the second time as described in the second ephemeris data; and
   calculating a measure of orbit data deviation between the orbit data for the first satellite at the second time and the orbit data for the first satellite at the second time as described in the second ephemeris data, and
using the measure of deviation to determine whether the model is faulty by:
   using the measure of clock error deviation and the measure of orbit data deviation to determine whether the model is faulty.

The computer code when executed by the one or more processors of the receiver apparatus may cause them to perform:
calculating the measure of deviation between the predicted clock error data and/or orbit data for the first satellite at the second time and the clock error data and/or orbit data for the first satellite at the second time as described in the second ephemeris data by calculating two or more of:
   a measure of along-track orbit deviation between the orbit data for the first satellite at the second time and the orbit data for the first satellite at the second time as described in the second ephemeris data;
   a measure of radial orbit data deviation between the orbit data for the first satellite at the second time and the orbit data for the first satellite at the second time as described in the second ephemeris data; and
   a measure of cross-track orbit data deviation between the orbit data for the first satellite at the second time and the orbit data for the first satellite at the second time as described in the second ephemeris data, and
wherein using the measure of deviation to determine whether the model is faulty may comprise:
   using the calculated measures of orbit data deviation to determine whether the model is faulty.

The computer code when executed by the one or more processors of the receiver apparatus may cause them to perform using the measure of deviation to determine whether the model is faulty by determining whether the measure of deviation has a predetermined relationship with respect to a threshold.

The computer code when executed by the one or more processors of the receiver apparatus may cause them to perform providing the threshold based on measures of deviation between predicted clock error data and/or orbit data for multiple satellites and clock error data and/or orbit data as described in ephemeris data broadcast by the multiple satellites.

The computer code when executed by the one or more processors of the receiver apparatus may cause them to perform determining whether there is a fault in models or parameters of the models for each of multiple satellites and, on a positive determination, refraining from using ranging signals originating from a set of satellites in positioning the receiver.

### BRIEF DESCRIPTION OF THE DRAWINGS

Embodiments of the present invention will now be described by way of example with reference to the accompanying drawings, in which:

FIG. 1 is a schematic drawing of a system including a received according to embodiments of the invention;

FIG. 2 shows satellite data stored in the receiver of FIG. 1; and

FIGS. 3 to 6 are flow charts illustrating operation of the receiver of FIG. 1 according to aspects of the invention.

### DETAILED DESCRIPTION OF EMBODIMENTS

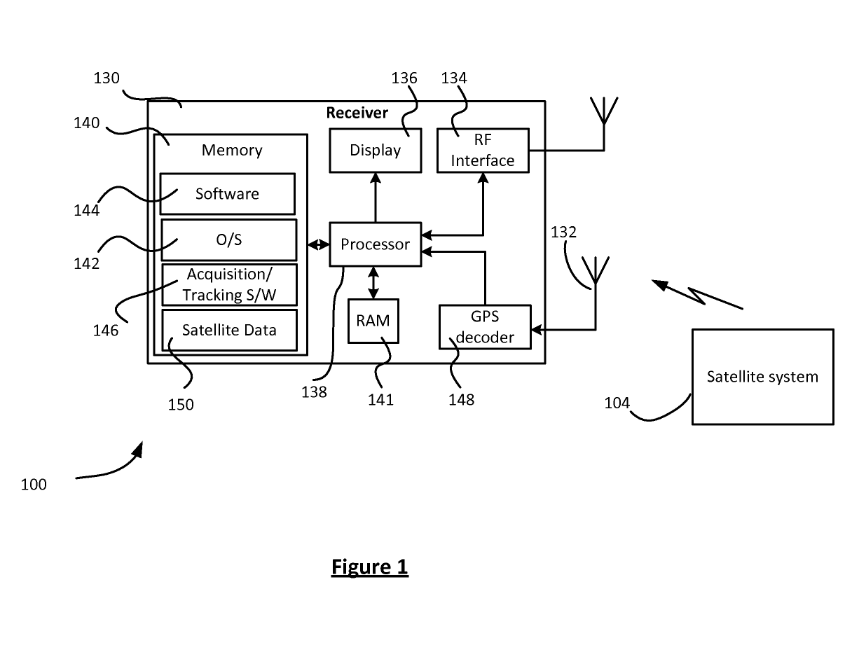

FIG. 1 is a block diagram of a system 100. The system includes the capability of collecting, creating, distributing and using assistance data.

The system 100 includes a satellite system 104. This may be a global or regional radio navigation satellite system such as Global Positioning System (GPS), GLONASS, GALILEO, COMPASS, SBAS (Satellite Based Augmentation System), QZSS (Quazi-Zenith Satellite System, Japan), IRNSS (Indian Regional Navigation Satellite System, India) or other satellite system. Each of these systems has a separate constellation of satellites, wherein each satellite has a managed orbit. Adjustments for maintenance or orbit corrections are often performed on an individual satellite basis but are performed by the constellation owner or management as needed.

The satellite system 104 broadcasts navigation data (ephemeris data, almanac data, ionosphere model, UTC model) or other satellite positioning data via a satellite link. This navigation data can be combined with ephemeris extension data files created separately of the satellite system 104 and is used to enhance the performance of a wireless receiving device 130, which can also be termed a receiver. In some embodiments, the ephemeris extension files can also be used as such for positioning purposes, totally replacing the broadcast ephemeris e.g. if the receiver is not able to receive navigation data from the satellites due to poor signal conditions. The following disclosure uses GPS as an illustrative system, although those skilled in the art will understand how to practise the invention in conjunction with other satellite positioning systems and their constellations.

The system 100 also includes the receiver 130. The receiver 130 may be a mobile phone, a handheld navigation system, digital camera, or an embedded navigation system such as a car safety system. The GPS signal is decoded with a GPS decoder/receiver 148. The receiver 130 is able to receive live telemetry, ephemeris data and almanac data from the satellite system 104 through its GPS antenna 132 and GPS decoder/receiver 148. The receiver 130 is able to communicate with a remote server (not shown) via an RF interface 134, which may take any suitable form. For instance, the RF interface 134 may be a modem which is utilised by API in the receiver 130 to setup e.g. a data or TCP/IP connection. The RF interface 134 is omitted in some embodiments.

The receiver 130 includes a display 136, a processor 138. The receiver 130 also includes memory. The memory includes non-volatile memory 140, such as ROM. The memory also includes volatile memory 141, for instance RAM. The processor 138 is bidirectionally connected to the memories 140, 141. The ROM 140 has stored within, amongst other things, an operating system 142, software 144 for programming the processor 138, and satellite acquisition/tracking software 146.

The operating system 142 contains code which, when executed by the processor 138 in conjunction with the RAM 141, controls operation of each of the hardware components of the receiver 130.

The software 144 is application software. The application software runs on the operating system 142.

The satellite acquisition/tracking software 146 provides satellite tracking and acquisition functions.

Briefly, embodiments of the invention are concerned with offline ephemeris extension, in which ephemeris extension data is produced locally within the receiver using e.g. models of the satellite mass centres, gravitational forces and solar wind, and BCE data received from satellites. Offline ephemeris extension data is not downloaded from a remote server, although some configuration parameters may be very occasionally updated.

In the receiver 130, orbits and clock error estimates predicted entirely or partly from ephemeris extension data (as defined by a model and parameters for the model) are compared to orbits and clock error estimates computed from BCE data received from satellites. In the following, the term ‘model’ will be understood to include parameters for the model. Orbits and clock error estimates are predicted using a locally stored model and possibly BCE data received at an earlier time. If too large a deviation is identified by the comparison for a given satellite, predictions for that satellite are not used, and the underlying ephemeris extension data may be discarded either temporarily or permanently. New ephemeris extension parameters for the long-term orbit and clock error estimates may be estimated from the BCE data or a new set of ephemeris extension data could be requested from the servers.

Through the features of the embodiments, errors in position calculations resulting from unexpected changes in satellite orbits, or satellite reconfigurations (including changes in identification), can be avoided. It can be said that the embodiments prevent the use of faulty predictions in the case of offline and/or server-generated extended ephemeris.

Faulty predictions can arise because satellites may be moved unexpectedly due to intentional rephasing, larger than expected solar wind, or due to unintentional problems in the satellite HW e.g. on-board atomic clock failures. Also, the actual satellite hardware related to a specific satellite identifier (in the case of GPS, this is the pseudorandom number, PRN, used to spread signals broadcast by the satellite) is changed, leading to using incorrect hardware and clock related parameters.

In the case of GLONASS satellites, the risks and consequences related to the constellation reconfiguration are somewhat different from the GPS constellation. GLONASS satellites do not have a signal specific PRN identifier, but the satellites (signals) are detected from their dedicated broadcast centre frequencies. Centre frequencies are unique for each visible satellite, although the same broadcast frequency is used by satellites at opposite positions in their orbit. The identification of the GLONASS satellites uses complex logic in the receiver. Assisted-GNSS standards define the GLONASS satellite identifier based on the orbital position i.e. slot ID, which is unique for each satellite. However, broadcast frequency allocations for a set of satellites can be changed without advance information.

In the case of online extended ephemeris, which is not a feature of these embodiments, the predictions are calculated by servers that can monitor the quality of the models in real time, because there is always data available about the satellites' true behaviour e.g. in the assistance data servers. Furthermore, satellite repositioning or reconfiguration events can even be taken into account beforehand. However, such is not possible for offline extended ephemeris.

The technique used in the embodiments contrasts with Receiver Autonomous Integrity Monitoring (RAIM). RAIM is used in receivers to detect and exclude satellites from position calculation if an error between a measured pseudorange and an expected pseudorange exceeds a predefined threshold. RAIM is not able to identify the source for the error, but is able to maintain the purity and consistency of the position fix within certain limits.

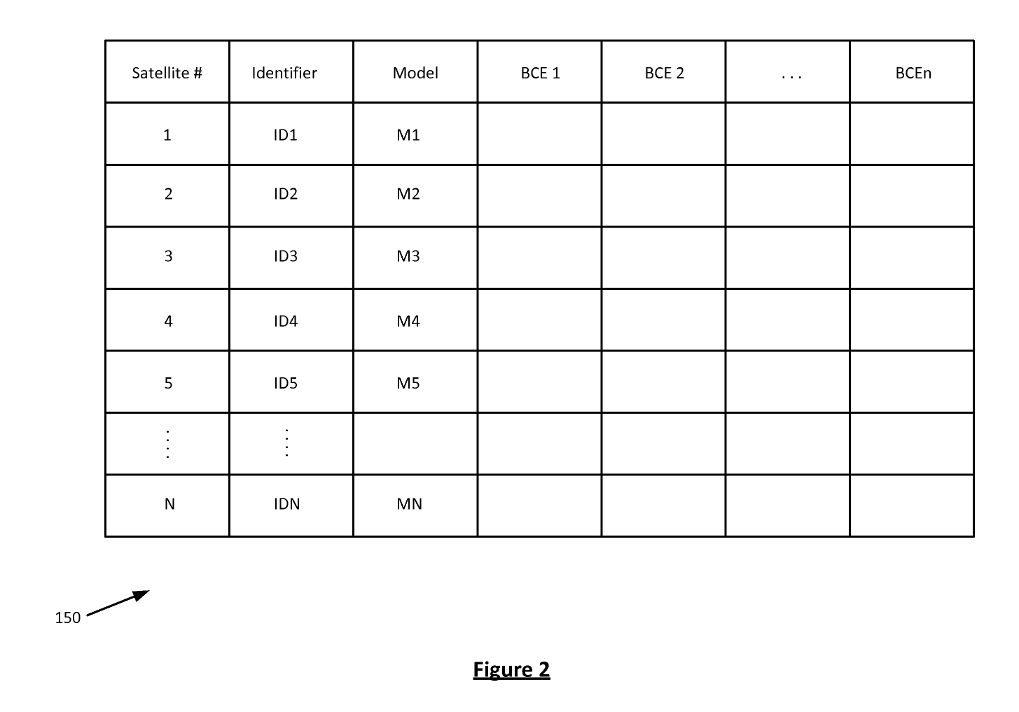

Stored in the ROM 140 of the receiver 130 is satellite data 150. This is shown in FIG. 2. The satellite data 150 may relate to satellites of just one constellation, for instance the GPS constellation, or they may relate to satellites of different constellations, for instance both GPS and GLONASS, constellations.

The satellite data 150 includes multiple data elements for each of multiple satellites. The satellites are referenced by a satellite number, provided in a first column of the data 150, which is internal to the receiver 130. Here, a row is provided for each of satellite numbers 1, 2, 3, 4, 5 . . . N.

For each satellite, an identifier is stored. This is an external identifier. For instance, the identifier in the case of a GPS satellite is the PRN that is used to spread signals broadcast by the satellite. In the case of a GLONASS satellite, the identifier is slot ID. The identifier may take any form that is appropriate, having regard to the satellite.

For each satellite, the satellite data 150 also includes a model. These are numbered M1, M2, M3 . . . MN in the figure. The model for a given satellite includes parameters from which orbit data and clock error data for the corresponding satellite can be calculated. The parameters model the orbit and clock error of the satellite using information such as the satellite's earlier orbital movements, earth, moon and sun gravity (force) models, solar wind pressure models and clock behaviour. The model is based partly on the parameters obtained from the BCE data received from the satellites, but part of the model may be based on hard-coded satellite specific parameters that characterise the satellite hardware and clock type, especially in relation to the force and solar wind pressure models. The model, including the parameters, constitutes ephemeris extension data.

The satellite data 150 also includes BCE data that has been received from the corresponding satellite, and includes memory allocation for BCE data that has not yet been received. In FIG. 2, columns are provided for n instances of BCE data, labelled BCE1, BCE2 . . . BCEn, for each satellite.

The satellite data 150 is populated by the receiver 130 during operation of the receiver. Parameters of the models M1 to MN may be changed by the receiver 130 from time to time as the receiver 130 determines that changes to the models are appropriate. Historical BCE data is stored in the satellite data iso, although it can be discarded once it has reached a certain age. However, old BCE may still have some value in the future, so is deleted only memory capacity is required for some other purpose.

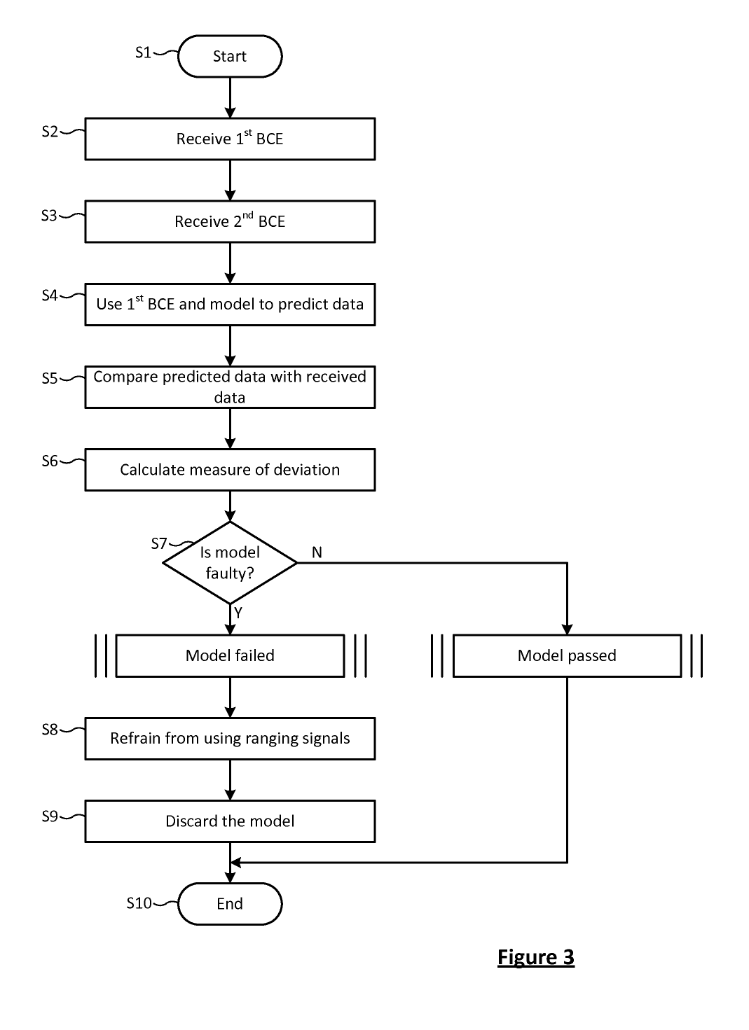

Operation of the receiver 130 will now be described with reference to FIG. 3. FIG. 3 relates to the operation of the receiver 130 in respect of one satellite. FIG. 3 does not relate to obtaining a positioning fix, but relates to maintenance of the satellite data 150 and monitoring for faulty models/faulty predictions.

The operation begins at step S1. At step S2, first BCE data is received for the satellite. This is stored in the relevant cell of the satellite data 150, as shown in FIG. 2. At step S3, second BCE data is received from the satellite. This is also stored in the relevant cell of the satellite data 150 of FIG. 2. Step S3 may be performed at a significantly later time than step S2. For instance, step S3 may be performed one, two or three days later than step S2 was performed. Advantageously, step S3 is performed at a time that is later than the time at which the first BCE data was received by an amount that is greater than the validity period of ephemeris data derived directly from the first BCE data.

At step S4, the first BCE data and the model for the satellite is used to predict orbit data and clock error data for the satellite at the time relating to the second BCE data. This prediction does not use the second BCE data, but instead uses only the first BCE data and the model. Alternatively, step S4 may involve using the model for the satellite, without the first BCE data, to predict orbit data and clock error data for the satellite at the time relating to the second BCE data. This prediction does not use the second BCE data nor the first BCE data, but instead uses only the model. Step S4 provides a prediction of clock error data and orbit data for the satellite at a time corresponding to the received second BCE data. The time corresponds to the received second BCE data in that it is within the validity period of the second BCE data.

At step S5, the predicted data is compared with the received BCE data. The nature of the comparison depends in particular on the nature of the data that is being compared.

At step S6, a measure of a deviation between the predicted data and the received data is calculated. An effect of step S6 is to provide a measure of the amount by which the actual orbit data and clock error data, as communicated by the second BCE data received from the satellite, deviated from the predicted clock error data and orbit data calculated by the receiver 130 on the basis of the first BCE data and the model, both of which are stored as part of the satellite data iso. The result of step S6 is to provide a measure of deviation, for instance as a numerical value.

At step S7, it is determined based on the measure of deviation whether the model for the satellite is faulty, either in terms of the model itself or one or more parameters of the model. The model may be determined to be faulty if the measure of deviation calculated at step S6 exceeds a threshold measure. If step S7 does not identify that the model is faulty, the model is deemed to have passed and the operation ends at step S10.

If step S7 determines that the model is faulty, the model is determined to have failed and action is taken. For instance, in step S8 the receiver 130 refrains from using ranging signals received from the corresponding satellite in positioning the receiver 130. This may be performed in any suitable way. For instance, the satellite may be flagged as being faulty, such that the receiver 130 does not use signals received from the corresponding satellite when positioning the receiver 130.

Also, at step S9 the model for the satellite may be discarded. Discarding of the model may be either temporary or permanent. The orbit model could still be valid if the error/anomaly is in the dock only. On determining that the error is in the clock only, the use of the orbit model is stopped for a while, and use of the model can be resumed after it is determined that the clock error estimates are again within acceptable limits. If the satellite has been rephased or in the worst case replaced by another vehicle, the model is discarded permanently.

Although not shown in FIG. 3, action taken upon determining that the model has failed may additionally or alternatively include updating the model. The model can be updated by the receiver 130, for instance, using the second BCE data to identify better parameters. The model can be updated by the receiver 130 by collecting multiple sets of BCE data from the satellite and using them to identify better parameters. Better parameters can be identified by identifying parameters that more closely provide clock error data and orbit data conforming to the second BCE data when the model is applied, with or without the first BCE data. Alternatively, the model may be updated using new configuration parameters that are received from a server following a request for those parameters.

After action is taken, the operation ends at step Sm.

It will be appreciated that positioning is not a part of the operation of FIG. 3. Positioning may be performed by the receiver 130 as and when required using the models M1 to MN and the latest BCE data stored as part of the satellite data iso. Positioning may be performed by the receiver 130 between steps S2 and S3, that is before receiving the second BCE data, using the model, and optionally also the latest BCE data, to predict ephemeris extension data for the particular time at which the positioning is occurring. After step S7 has been performed, ranging signals from a satellite are used in positioning only if the model for the satellite has been passed.

When receiving signals from satellites to provide ranging information and obtain a positioning fix for the receiver 130, the receiver 130 is not normally activated for a sufficiently long period in order to decode BCE data from the satellites. Instead, BCE data is received only occasionally. The BCE data is received sufficiently frequently that, at a given time, ephemeris extension data that can be calculated by the receiver 130 using the model and the most recently stored BCE data is within the validity period permitted by the model. However, BCE data is not received from satellites any more frequently than is needed, in order to minimise power consumption at the receiver 130.

Step S7 of FIG. 3 is performed for a given satellite relatively infrequently. For instance, it is performed shortly after receiving BCE data from a satellite. Put another way, step S4 of FIG. 3, in which clock error data and orbit data is predicted using the model and old BCE data, is performed at about the same time as step S3, in which up to date BCE data is received. In this way, checking by the receiver 130 for faulty predictions does not require the receiver 130 to receive BCE data from satellites any more frequently than is required to maintain sufficiently up to date BCE data within the satellite data 150. However, the prediction of clock error data and orbit data and the determination of whether a model is faulty need not be performed every time that updated BCE data is received from a satellite.

The operation of FIG. 3 relates to only one satellite. The operation of FIG. 3 is performed for each satellite from which ranging signals are received at the receiver 130. The operation of FIG. 3 may be performed for each satellite entirely independently of performance of the operation for other satellites. For instance, the receiver 130 may receive BCE data for a given satellite as required to ensure that ephemeris extension data calculated using the model and old BCE data is not invalid, and perform a check for faulty predictions at that time.

It will be appreciated that step S7 determines that a model for a satellite is faulty not because of minor inaccuracies in the model parameters but because a satellite has been repositioned, has developed a fault or has been reconfigured, or because there has been a significant error in one or more parameters. An error in a parameter of the model might result for instance from an incorrect identification of the effect of the solar wind on the particular model or type of the satellite. The detection of faulty models in this way provides a straightforward manner by which the receiver 130 can identify satellites from which ranging measurements should be excluded from position calculations. RAIM may be performed when positioning the receiver 130, and the operation of FIG. 3 is performed independently of positioning.

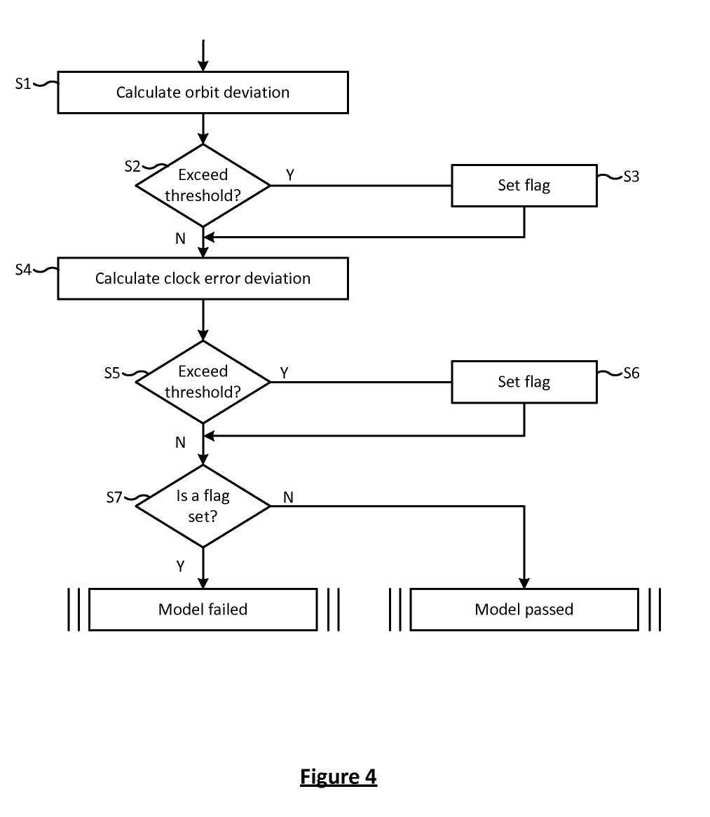

Steps S6 and S7 of FIG. 3 may be performed in any suitable way. One particular way of achieving the performance of steps S6 and S7 will now be described with reference to FIG. 4.

At step S1 of FIG. 4, orbit deviation is calculated. Clock error deviation is calculated at step S4, separately to calculation of orbit deviation in step S1.

Orbit deviation can be calculated at step S1 in any suitable way. The deviation may be calculated in terms of an absolute quantity, or in terms of some artificial metric, for instance. At step S2, it is determined whether the orbit deviation exceeds a threshold. If the threshold is exceeded, a flag is set at step S3. Following step S3 or following a negative determination at step S2, the operation proceeds to step S4, where clock error deviation is calculated.

Step S4 may be performed in any suitable way. The dock error deviation may be calculated in terms of an absolute measure of time, or in terms of an artificial metric. At step S5 it is determined whether the clock error deviation calculated in step S4 exceeds a threshold. On a positive determination, a flag is set at step S6. Following step S6, or following a negative determination from step S5, the operation proceeds to step S7.

At step S7, it is determined whether a flag has been set. If a flag was set at step S3 or at step S6, a positive determination results from step S7 and it is determined that the model has failed. This results in the actions at steps S8 and S9 of FIG. 3 being performed. On a negative determination from step S7, it is determined that the model has passed. This results in the operation of FIG. 3 ending at step S10.

On a positive determination from step S7, the flags may be reset, so that they can be set by steps S3 and S6 on a subsequent performance of the operation of FIG. 4 as required.

It will be appreciated that the calculation of the orbit deviation and the comparison of that to a threshold may be performed after the calculation of the clock error deviation and the comparison of that to a threshold. Alternatively, a positive determination that a threshold has been exceeded at either of steps S2 and S5 may result in the operation of FIG. 4 proceeding directly to the action(s) that result from a determination that the model has failed.

FIG. 4 illustrates that deviation of the predicted orbit from the orbit identified by recently received BCE data is assessed independently from deviation of predicted clock error from clock error indicated from recently received BCE data.

Alternatively, in other embodiments, only deviation between the predicted and actual data for the orbit of the satellite is used in determining whether the model for the satellite is faulty. In other embodiments, orbit is not considered in determining a faulty model, and instead only a deviation between predicted clock error and actual clock error is used in identifying a faulty model. If orbits are not observable e.g. in the case of geostationary satellites, the satellites are virtually in the same position and the clock error is the factor that is used to determine whether a model is faulty.

A variation of the operation described above will now be described, also with reference to FIG. 3. This alternative is performed in certain embodiments of the invention.

In these alternative embodiments, all of the steps described above are performed, and there are additional steps. In particular, further BCE data is received, the further BCE data relating to one or more times that are different to the time to which the second BCE data relates. The further BCE data may comprise just third BCE data, or it may comprise a time series of third, fourth and optionally fifth etc. BCE data.

In these alternative embodiments, step S4 involves using the model, and optionally also the first BCE data, to predict orbit data and clock error data for the satellite at the time or times corresponding to the further BCE data, as well as the second BCE data. Step S5 then involves multiple comparisons, since there are multiple sets of predicted data and multiple sets of received data, and step S6 involves calculating multiple measures of deviation. Here, step S7 provides a determination that the model is faulty if the amount of deviation for any of the sets of BCE data is too large.

Here, the further set or sets of BCE data are nearer in time to the second BCE data than the second BCE data is to the first BCE data. Put another way, the second and further set or sets or BCE data are relatively close to one another in time. For instance, the separation between the second and subsequent sets of BCE data may be a few hours, compared to a few days between the first BCE data and the second BCE data.

By using a time series of predicted and actual BCE data in this way, a model may be correctly identified as being a faulty model even in the presence of a systematic error or bias that may not be apparent at a single moment in time (as could occur if the bias was not apparent at the time of the second BCE data.

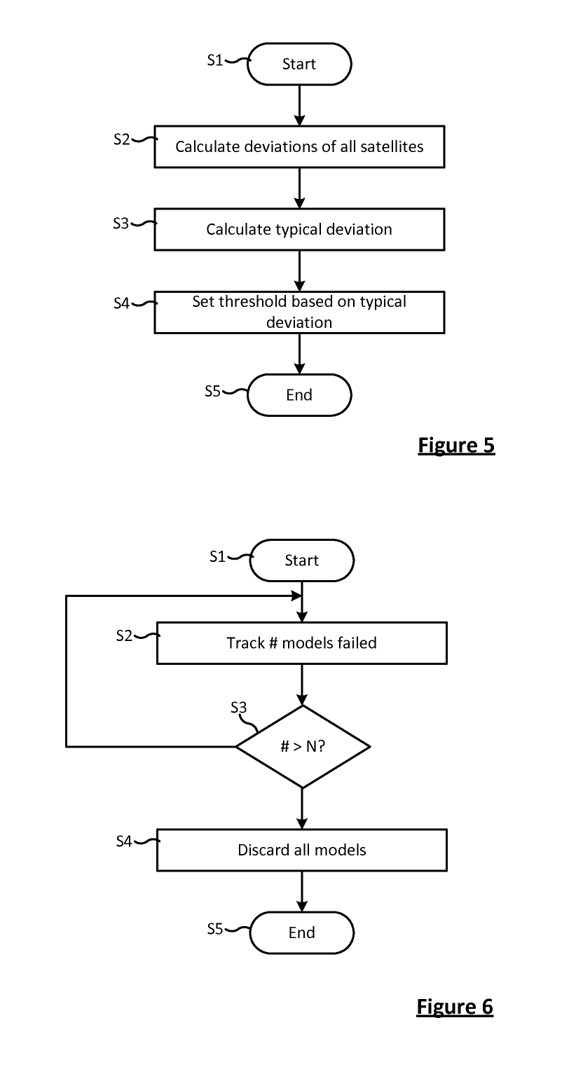

FIGS. 3 and 4 relate to operations performed in respect of a single satellite, although these operations are performed for each of the satellites for which data is stored in the satellite 150. In some embodiments, deviations between predicted and actual data for multiple satellites is taken into account when determining whether a model for one satellite is faulty. This will now be described with reference to FIG. 5.

In FIG. 5, the operation starts at step S1. At step S2, deviations are calculated for all satellites for which data is stored in the satellite data 150. The deviations may be calculated in terms of orbit deviations only, clock error deviations only, or both orbit and clock error deviations. The calculation of the deviations for all of the satellites at step S2 may be performed over a long period of time. For instance, the receiver 130 may be configured to store in the satellite data 150 the measure of deviation calculated at step S6 of FIG. 3 when FIG. 3 is performed for a given satellite. As such, deviations for all satellites may not need to be performed at a single time.

At step S3, a typical deviation is calculated. This may be performed in any suitable way. For instance, it may involve calculating a median value of deviation. Using the median value is advantageous since it excludes extremes from the calculation, such as may result from faulty models. However, the identification of the mean deviation may be a viable alternative to perform step S3 of FIG. 5.

At step S4, a threshold deviation is set based on the typical deviation calculated at step S3. This may be performed in any suitable way. For instance, the threshold deviation may be set in terms of a multiple of the typical deviation. The multiple may for instance be 1.5 or 2 times the typical deviation. Alternatively, it may be set as a predetermined amount above the typical deviation calculated at step S3. Following step S4, the operation ends at step S5.

Following the operation of FIG. 5, the threshold set at step S4 is used in performance of the operation of FIG. 3. In particular, the threshold is used in step S7 of FIG. 3 in determining whether the model for a given satellite is faulty. Here, the same threshold is used in respect of each of the satellites. Using a threshold based on typical deviation between predicted data and actual data for satellites provides a dynamic exclusion threshold. This can help to ensure that models for satellites are not deemed to be faulty because of relatively minor influences that apply to all or most of the satellites in a constellation.

The receiver 130 performs the operation shown in FIG. 6, as will now be described. At step S1, the operation begins. At step S2, the number of models that are determined to have failed is tracked. If at step S3 the number of models that are determined to have failed is determined to have exceeded a threshold N, action is taken at step S4. The action may involve discarding all models for all satellites. It may alternatively involve updating the models for all satellites. It may alternatively or additionally involve obtaining assistance data (including ephemeris data) or new model configuration data from a remote server. On a negative determination from step S3, the operation returns to step S2, where the number of models that have failed is again tracked. Following step S4, the operation ends at step S5.

A number of advantages deriving from the above-described features will be apparent. In particular, repositioned or reconfigured satellites can be identified and excluded from being used for positioning measurements. The exclusion can be either temporary or permanent. The exclusion can be applied to individual satellites, to groups of satellites or even to entire constellations.

Systematic biases and drifts can be detected with the time series approach that was described as an alternative to the operation of FIG. 3.

Also, the quality of orbit and/or clock error prediction processes can be monitored, to ensure that positioning accuracy is maintained.

The amount of deviation that is permitted before a model for a satellite is deemed to be faulty can be predefined or alternatively dynamically defined. Positioning fixes with an accuracy within defined performance targets can be achieved in either instance.

If the action taken in response to determining that a model is faulty includes updating the model, the above-described features can allow for the model for a satellite to be again permitted to be used for positioning determination once the model has been verified as not being faulty.

The features described above allow implementation with respect to any satellite system, including GPS, GLONASS, Galileo etc. and any type of the satellite orbit, Low-Earth Orbit (LEO), Medium-Earth Orbit (MEO), Geostationary Earth Orbit (GEO), Inclined Geosynchronous Orbit (IGSO) etc.

Numerous alternatives will be envisaged by those skilled in the art and are intended to be encompassed by the invention, which is limited only by the appended claims and their equivalents.

For instance, although in the above receiver operation is offline and no assistance data is received from servers through a cellular etc. connection, the collection of such assistance data is not precluded. The above-described features allow the detection of faulty models/parameters for satellites in both offline and online cases. The detection of faulty models/parameters in online cases may become more useful as the validity of online ephemeris extension data increases towards and beyond 30 days.

Additionally, thresholds that can be set separately for different satellites may be provided. For instance, different thresholds of clock error may be set for different satellites, with different dock error differences then giving rise to faulty model determinations for different satellites. This can be useful for instance in the event that the historical data of a specific satellite indicates that the satellite has an unstable clock. A relatively high error in that satellite's clock prediction might then ordinarily be expected, although such would not imply that the satellite hardware has been changed. Having a higher threshold for this satellite allows the model to remain undiagnosed as faulty even if the difference between predicted and actual clock error is determined to be high. On the other hand, if another satellite has a very accurate clock that is easy to predict forward, a faulty model/parameters may be determined on the basis of a difference between predicted and actual clock error that would not be abnormal for other satellites. Providing different thresholds in these two cases provides better receiver operation in the sense that a faulty model/parameters may be more reliably detected. Different thresholds for different satellites may be calculated by the receiver dynamically, based on historical data.

Different orbit thresholds may be applied to satellites of different constellations (GPS/GLONASS/BEIDOU etc). Because some constellations have orbits that are easier to predict than others, different errors between predicted and actual orbits can be experienced for satellites from different constellations. Different thresholds for different satellite constellations may be calculated by the receiver dynamically, based on historical data.

Different orbit thresholds may be applied to satellites of different types or models. This may improve receiver operation if for instance models of clock errors of the effects of the solar wind on a particular type/model of satellite is inaccurate. Different thresholds for different satellite types/models may be calculated by the receiver dynamically, based on historical data.

Different thresholds of clock error may additionally or alternatively be set for different satellite orbits, satellite generations etc.

By calculating thresholds dynamically, the receiver operates heuristically.

Although the above embodiments relate to a GPS system, the scope of the invention is not limited to this. For instance, the invention is applicable also to other navigation systems involving predictions of satellite data, including the GLONASS, COMPASS, GALILEO, SBAS, QZSS, BEIDOU and IRNSS satellite networks as well as to GNSS systems that utilise signals received from plural constellations.

1-31. (canceled)

32. A method comprising:
storing, by a receiver apparatus, a model with parameters for extending ephemeris data for a first satellite;
receiving, by the receiver apparatus, first ephemeris data from the first satellite, the first ephemeris data relating to clock error data and/or orbit data for the first satellite at a first time;
receiving, by the receiver apparatus, second ephemeris data from the first satellite, the second ephemeris data relating to clock error data and/or orbit data for the first satellite at a second time;
using, by the receiver apparatus, the model to predict clock error data and/or orbit data for the first satellite at the second time;
calculating, by the receiver apparatus, a measure of deviation between the predicted clock error data and/or orbit data for the first satellite at the second time and the clock error data and/or orbit data for the first satellite at the second time as described in the second ephemeris data;
using, by the receiver apparatus, the measure of deviation to determine whether there is a fault in the model or parameters of the model; and
on a positive determination, refraining, by the receiver apparatus, from using ranging signals originating from the first satellite in positioning the receiver apparatus.

33. The method as claimed in claim 32, further comprising, on a positive determination, discarding, by the receiver apparatus, the model for extending ephemeris data for the first satellite.

34. The method as claimed in claim 32, further comprising, on a positive determination, using, by the receiver apparatus, received ephemeris data to update the model for extending ephemeris data for the first satellite.

35. The method as claimed in claim 32, wherein using the model to predict clock error data and/or orbit data for the first satellite at the second time comprises using the model and the first ephemeris data to predict clock error data and/or orbit data for the first satellite at the second time.

36. The method as claimed in claim 32, further comprising:
receiving, by the receiver apparatus, third ephemeris data from the first satellite, the third ephemeris data relating to clock error data and/or orbit data for the first satellite at a third time;
calculating, by the receiver apparatus, a second measure of deviation between the predicted clock error data and/or orbit data for the first satellite at the third time and the clock error data and/or orbit data for the first satellite at the third time as described in the third ephemeris data; and
using, by the receiver apparatus, both measures of deviation to determine whether the model is faulty.

37. The method as claimed in claim 32,
wherein calculating the measure of deviation between the predicted clock error data and/or orbit data for the first satellite at the second time and the clock error data and/or orbit data for the first satellite at the second time as described in the second ephemeris data comprises:
calculating, by the receiver apparatus, a measure of clock error deviation between the predicted clock error data for the first satellite at the second time and the clock error data for the first satellite at the second time as described in the second ephemeris data; and
calculating, by the receiver apparatus, a measure of orbit data deviation between the orbit data for the first satellite at the second time and the orbit data for the first satellite at the second time as described in the second ephemeris data, and
wherein using the measure of deviation to determine whether the model is faulty comprises:
using, by the receiver apparatus, the measure of clock error deviation and the measure of orbit data deviation to determine whether the model is faulty.

38. The method as claimed in claim 32,
wherein calculating the measure of deviation between the predicted clock error data and/or orbit data for the first satellite at the second time and the clock error data and/or orbit data for the first satellite at the second time as described in the second ephemeris data comprises calculating two or more of:
a measure of along-track orbit deviation between the orbit data for the first satellite at the second time and the orbit data for the first satellite at the second time as described in the second ephemeris data;
a measure of radial orbit data deviation between the orbit data for the first satellite at the second time and the orbit data for the first satellite at the second time as described in the second ephemeris data; and
a measure of cross-track orbit data deviation between the orbit data for the first satellite at the second time and the orbit data for the first satellite at the second time as described in the second ephemeris data, and
wherein using the measure of deviation to determine whether the model is faulty comprises:
using, by the receiver apparatus, the calculated measures of orbit data deviation to determine whether the model is faulty.

39. The method as claimed in claim 32, wherein using the measure of deviation to determine whether the model is faulty comprises determining whether the measure of deviation has a predetermined relationship with respect to a threshold.

40. The method as claimed in claim 32, comprising providing the threshold based on measures of deviation between predicted clock error data and/or orbit data for multiple satellites and clock error data and/or orbit data as described in ephemeris data broadcast by the multiple satellites.

41. An apparatus having a least one processor and at least one memory having computer-readable code stored thereon which when executed controls the at least one processor:
to store a model with parameters for extending ephemeris data for a first satellite;
to receive first ephemeris data from the first satellite, the first ephemeris data relating to clock error data and/or orbit data for the first satellite at a first time;
to receive second ephemeris data from the first satellite, the second ephemeris data relating to clock error data and/or orbit data for the first satellite at a second time;
to use the model to predict clock error data and/or orbit data for the first satellite at the second time;
to calculate a measure of deviation between the predicted clock error data and/or orbit data for the first satellite at the second time and the clock error data and/or orbit data for the first satellite at the second time as described in the second ephemeris data;
to use the measure of deviation to determine whether there is a fault in the model or parameters of the model; and
on a positive determination, to refrain from using ranging signals originating from the first satellite in positioning the receiver apparatus.

42. The apparatus as claimed in claim 41, wherein the computer-readable code when executed further controls the at least one processor, on a positive determination, to discard the model for extending ephemeris data for the first satellite.

43. The apparatus as claimed in claim 41, wherein the computer-readable code when executed further controls the at least one processor, on a positive determination, to use received ephemeris data to update the model for extending ephemeris data for the first satellite.

44. The apparatus as claimed in claim 41, wherein the computer-readable code when executed further controls the at least one processor to use the model to predict clock error data and/or orbit data for the first satellite at the second time by using the model and the first ephemeris data to predict clock error data and/or orbit data for the first satellite at the second time.

45. The apparatus as claimed in claim 41, wherein the computer-readable code when executed further controls the at least one processor:
to receive third ephemeris data from the first satellite, the third ephemeris data relating to clock error data and/or orbit data for the first satellite at a third time;
to calculate a second measure of deviation between the predicted clock error data and/or orbit data for the first satellite at the third time and the clock error data and/or orbit data for the first satellite at the third time as described in the third ephemeris data; and
to use both measures of deviation to determine whether the model is faulty.

46. The apparatus as claimed in claim 41, wherein the computer-readable code when executed further controls the at least one processor:
to calculate calculating the measure of deviation between the predicted clock error data and/or orbit data for the first satellite at the second time and the clock error data and/or orbit data for the first satellite at the second time as described in the second ephemeris data by:
calculating a measure of clock error deviation between the predicted clock error data for the first satellite at the second time and the clock error data for the first satellite at the second time as described in the second ephemeris data; and
calculating a measure of orbit data deviation between the orbit data for the first satellite at the second time and the orbit data for the first satellite at the second time as described in the second ephemeris data, and
to use the measure of deviation to determine whether the model is faulty by:
using the measure of clock error deviation and the measure of orbit data deviation to determine whether the model is faulty.

47. The apparatus as claimed in claim 41, wherein the computer-readable code when executed further controls the at least one processor:
to calculate the measure of deviation between the predicted clock error data and/or orbit data for the first satellite at the second time and the clock error data and/or orbit data for the first satellite at the second time as described in the second ephemeris data by calculating two or more of:
a measure of along-track orbit deviation between the orbit data for the first satellite at the second time and the orbit data for the first satellite at the second time as described in the second ephemeris data;
a measure of radial orbit data deviation between the orbit data for the first satellite at the second time and the orbit data for the first satellite at the second time as described in the second ephemeris data; and
a measure of cross-track orbit data deviation between the orbit data for the first satellite at the second time and the orbit data for the first satellite at the second time as described in the second ephemeris data, and
to use the measure of deviation to determine whether the model is faulty by:
using the calculated measures of orbit data deviation to determine whether the model is faulty.

48. The apparatus as claimed in claim 41, wherein the computer-readable code when executed further controls the at least one processor to use the measure of deviation to determine whether the model is faulty by determining whether the measure of deviation has a predetermined relationship with respect to a threshold.

49. The apparatus as claimed in claim 41, wherein the computer-readable code when executed further controls the at least one processor to provide the threshold based on measures of deviation between predicted clock error data and/or orbit data for multiple satellites and clock error data and/or orbit data as described in ephemeris data broadcast by the multiple satellites.

50. The apparatus as claimed in claim 41, wherein the computer-readable code when executed further controls the at least one processor to determine whether there is a fault in models or parameters of the models for each of multiple satellites and, on a positive determination, to refrain from using ranging signals originating from a set of satellites in positioning the receiver.

51. A computer readable medium having non-transiently stored therein computer code that when executed by one or more processors of a receiver apparatus causes a method comprising:
storing a model with parameters for extending ephemeris data for a first satellite;
receiving first ephemeris data from the first satellite, the first ephemeris data relating to clock error data and/or orbit data for the first satellite at a first time;
receiving second ephemeris data from the first satellite, the second ephemeris data relating to clock error data and/or orbit data for the first satellite at a second time;
using the model to predict clock error data and/or orbit data for the first satellite at the second time;
calculating a measure of deviation between the predicted clock error data and/or orbit data for the first satellite at the second time and the clock error data and/or orbit data for the first satellite at the second time as described in the second ephemeris data;
using the measure of deviation to determine whether there is a fault in the model or parameters of the model; and
on a positive determination, refraining from using ranging signals originating from the first satellite in positioning the receiver apparatus.
